(19) United States
(12) Patent Application Publication
(10) Pub. No.: US 2007/0005507 A1
(43) Pub. Date: Jan. 4, 2007

(54) METHOD OF AUTOMATICALLY PAYING FOR A FRANKING SERVICE

(75) Inventors: Fabien CHATTE, Nogent sur Marne (FR); Ruben RICO, Paris (FR)

Correspondence Address: SUGHRUE MION, PLLC, 2100 PENNSYLVANIA AVENUE, N.W., SUITE 800, WASHINGTON, DC, 20037, US

(73) Assignee: NEOPOST TECHNOLOGIES, Bagneux (FR)

(21) Appl. No.: 11/427,642

(22) Filed: Jun. 29, 2006

(30) Foreign Application Priority Data
Jun. 30, 2005 (FR) 0506685

(51) Int. Cl. G06Q 99/00

(52) U.S. Cl. 705/62

(57) ABSTRACT

A method of automatically paying for a franking service in a self-service mail-handling machine, in which method the user inputs parameters of the requested franking service into the mail-handling machine which displays a first item of encoded information relating to the requested franking service, the user captures said first item of encoded information by means of a handheld communications device which automatically sends a payment request to a first server system which receives said request, verifies the entitlements of the user and, if said entitlements are valid, generates a second item of encoded information and sends it to the handheld communications device for display, and the user transmits said second item of encoded information to the mail-handling machine which verifies whether said second item of encoded information as received is valid, and, if it is valid, implements the requested franking service.

### TECHNICAL FIELD

The present invention relates exclusively to the field of mail handling, and it relates more particularly to a method of automatically paying for a franking service in a self-service mail-handling machine.

### STATE OF THE ART

Today, if it is desired to use a self-service mail-handling machine in a public place, it is necessary to have either coins or a prepaid card, or indeed a credit card or bank payment card. Coin-operated machines are exposed to vandalism from certain users, and are tending to disappear from public places, while machines operated by prepaid cards presuppose being in possession of a valid card credited with a sufficient monetary amount, which can constitute a difficulty when the mail-handling machine is used outside the opening hours of the public service upon which it depends as a general rule. As for machines operated by credit cards or bank payment cards, they require a confidential code to be input, which can be problematic in a public place. In addition, incorporating a credit card reader into the mail-handling machine significantly increases the costs of manufacturing it and of operating it.

Therefore, there exists a need that is currently unsatisfied for an alternative method of payment that is particularly simple to implement and that avoids the above-mentioned drawbacks for purchasing a franking service in a public place having a mail-handling machine used on a self-service basis.

### DISCLOSURE OF THE INVENTION

The present invention thus provides a novel method of automatically paying for a franking service in a self-service mail-handling machine, said method comprising the following steps:

a user inputting the parameters of the requested franking service into the mail-handling machine;

the mail-handling machine generating a first item of encoded information relating to the requested franking service;

a handheld communications device of the user obtaining the first item of encoded information;

the handheld communications device automatically sending a payment request for paying for the requested franking service to a first server system;

the first server system receiving said request and verifying the use entitlements of the user;

if the use entitlements are valid, the first server system generating a second item of encoded information in response to the payment request for paying for the franking service;

the handheld communications device of the user obtaining said second item of encoded information;

transmitting the second item of encoded information obtained in this way by the handheld communications device to the mail-handling machine;

the mail-handling machine verifying the second item of encoded information transmitted in this way; and

if the received second item of encoded information is valid, activating the mail-handling machine so as to implement the requested franking service.

Thus, the use of a mobile phone or “cellphone” makes it possible to pay for the requested franking service automatically while avoiding the above-mentioned drawbacks of payment in cash or by card.

The step of verifying the use entitlements comprises verifying the telephone number of the user and verifying the corresponding telephone credit with a second server system.

Preferably, each of said first and second items of encoded information is in the form of an advantageously two-dimensional bar code.

Depending on the implementation in question, the step of obtaining said first item of encoded information may comprise the handheld communications device receiving a radio frequency or infrared signal transmitted by the mail-handling machine and including said second item of encoded information, or digitally capturing said first item of encoded information by photographing a screen of the mail-handling machine by means of a digital camera incorporated in the handheld communications device of the user.

The step of automatically sending the payment request for paying for the franking service comprises sending a Short Message Service (SMS) message to a phone number extracted automatically from said first item of encoded information which further includes at least the amount of the requested franking service and the identity number of the mail-handling machine.

The step of sending the second item of encoded information comprises sending an SMS message including the second item of encoded information to the handheld communications device of the user.

The step of transmitting the second item of encoded information to the mail-handling machine comprises the handheld communications device transmitting a radio frequency or infrared signal including said second item of encoded information, or presenting a screen of the handheld communications device to a bar code reader of the mail-handling machine.

### BRIEF DESCRIPTION OF THE DRAWINGS

Other characteristics and advantages of the present invention appear more clearly from the following description given by way of non-limiting indication, and with reference to the accompanying drawings, in which:

FIGS. 1A and 1B show two examples of network architecture making it possible to implement the method of the invention for automatically paying for a franking service; and

FIG. 2 is a flow chart showing the various steps of the method of the invention.

### IMPLEMENTATION(S) OF THE INVENTION

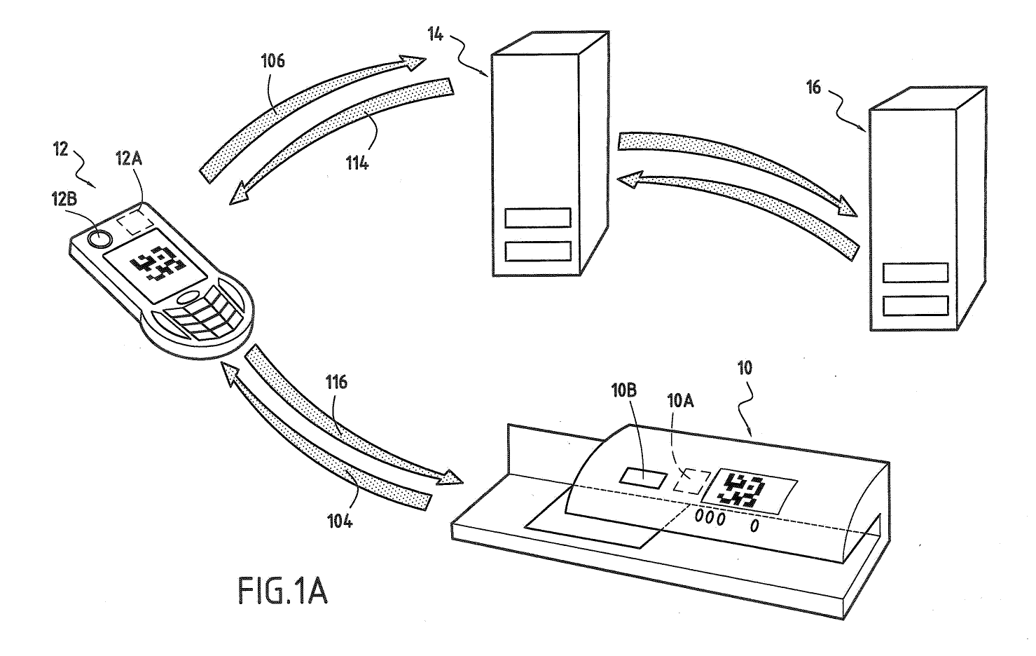

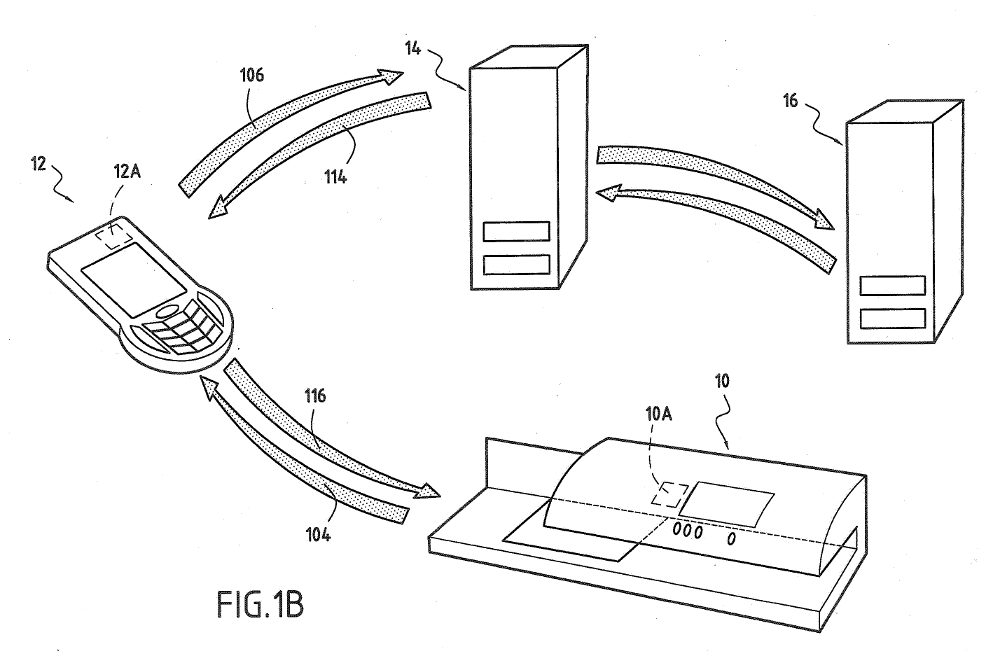

The principle of the invention is based on replacing the current cash or card payment for franking services in self-service franking machines or postage meters with payment by means of a handheld communications device. For this purpose, and as shown in FIGS. 1A and 1B, it is proposed to a user of a mail-handling machine 10 who wishes to frank (i.e. to print a postage amount on) one or more mail items to input into the machine the various parameters necessary for performing the franking, to be automatically put into connection, by means of a handheld communications device 12 in the user's possession receiving an item of encoded information from the machine, with a franking service payment server system 14, to receive on the handheld communications device, in response to that call, a second item of encoded information, and to transmit said second item of encoded information to the mail-handling machine so as to validate the requested franking service(s), the amount of the corresponding franking transaction being debited directly from the telephone account held by the user with a server system 16 of the user's telephone operator.

The mail-handling machine 10 is a standard machine disposed in a public place and thus for self-service use, and it incorporates a short-range wireless data transmit/receive module 10A serving to co-operate with an associated transmit/receive module incorporated in the handheld communications device, and, depending on the implementation in question, said mail-handling machine incorporates an advantageously two-dimensional bar code reader 10B. Optionally and as is known, the mail-handling machine can incorporate a weighing module, and said machine has a user interface with an integrated screen. The user interface makes it possible for various parameters relating to the requested franking service (class of mail, carrier used, country of destination, desired logo, etc.) to be input by the user, and it displays, in particular, the amount of the franking transaction, and a first item of encoded information once inputting the parameters is complete. It thus includes at least one screen which can then be touch-sensitive or more conventionally a liquid crystal diode (LCD) display associated with a keypad having function keys.

The handheld communications device 12 can be any data-processor device making it possible to perform long-range wireless communications through a terrestrial or satellite wireless telecommunications network (such as the following networks: Global System for Mobile Communications (GSM), Universal Mobile Telecommunications System (UMTS), Worldwide Interoperability for Microwave Access (WIMAX), etc.), such as a mobile or portable telephone or “cellphone”, a communicating personal digital assistant, or indeed a communicating portable computer or “laptop”. However, the handheld communications device must include a short-range wireless data transmit/receive module 12A for co-operating with the associated transmit/receive module of the mail-handling machine when said mail-handling machine is provided with such a module, and, depending on the implementation in question, must include a digital capture device 12B such as digital camera or an advantageously two-dimensional code bar reader. The transmit/receive module 12A and the transmit/receive module 10A of the mail-handling machine can be infrared modules or radio frequency modules, e.g. of the Bluetooth type, of the IEEE802.11x type or of the contactless chip type.

The server system 14 disposed on a site of the operator of the mail-handling machine or on the site of the postal administration comprises one or more central processing units containing one or more databases and conventionally one or more computer terminals (not shown) for the purposes of controlling and managing the system. The server system 16 of the telephone operator has a similar structure with one or more databases, in particular a customer database including accounting data.

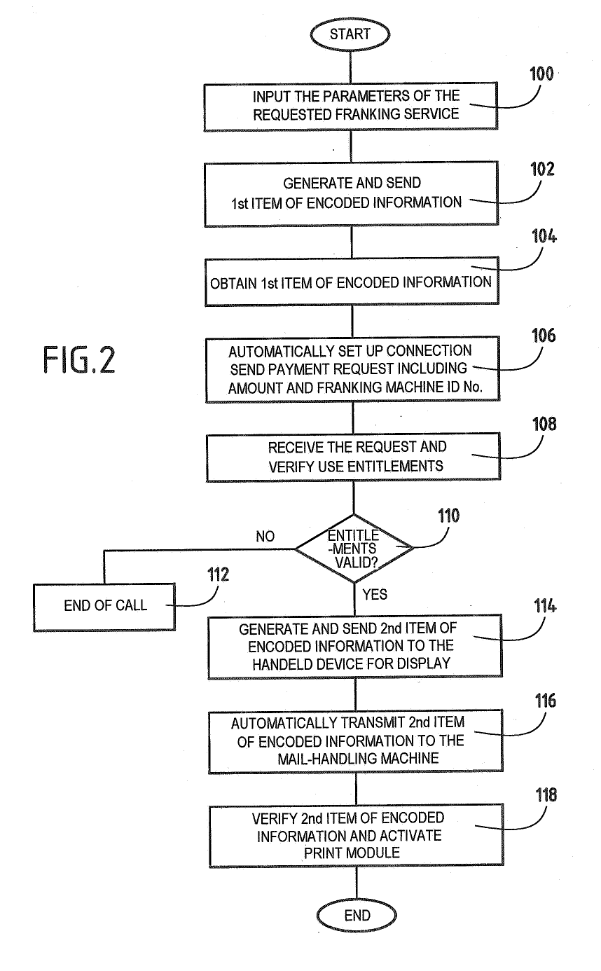

FIG. 2 is a flow chart showing the various steps making it possible to unlock the mail-handling machine in order to allow the user to perform the franking operation (see also FIGS. 1A and 1B).

In a first step 100, the user inputs the various parameters necessary for the requested franking service into the mail-handling machine, i.e. by following the instructions given by the machine and by using the user interface of said machine, the user selects the various operations necessary for implementing the requested franking service, such as determining the destination of the mail or determining the desired class of mail (e.g. Chronopost®), the required logo or advertising slogan, and optionally the class of weight when a weighing module is not available. Naturally, these operations can be repeated for an entire batch of mail items when the chosen franking service is a batch franking service.

Once these operations have been performed, the franking machine displays the total amount of the requested franking service(s) and, if the user accepts said amount, the franking machine then, in a second step 102, generates a first item of encoded information (i.e. information that is unintelligible to the user) for guaranteeing the validity of the subsequent processing by the first server system, said item of encoded information, which is addressed to the handheld communications device 12, being developed not only on the basis of said amount and of various other data relating to the transaction, e.g. the identity number of the mail-handling machine, the date or time of the transaction, or indeed the various parameters of the requested franking service(s), but also on the basis of an identifier of the payment service that serves to put the user automatically into communication with the server system 14 of said payment service so as to obtain a franking authorization. For example, said identifier is a telephone number or a short number of the SMS type (but it is also possible to imagine using a Wireless Application Protocol (WAP) address or an Internet address). Depending on the implementation in question, said first item of encoded information can be in the form of a preferably two-dimensional bar code which is then displayed on a viewing screen of the mail-handling machine (FIG. 1A).

The next step 104 consists in the user's handheld communications device obtaining said first item of information. Depending on the implementation in question, this can be achieved by photography (digital capture) or by directly reading the encoded information displayed on the viewing screen of the mail-handling machine (FIG. 1A), or by radio frequency transmission between the transmit/receive means of the mail-handling machine and of the handheld communications device (FIG. 1B).

Then, in a step 106, the handheld communications device decodes the received information and, in particular, extracts the identifier (phone number) of the payment service that enables said device to send a payment request for paying for the requested franking service automatically to a first server system, said request including at least the identity number of the mail-handling machine, and the total amount of the requested franking service(s), which amount is also extracted from the received information. The form of the request naturally depends on the type of interface used at the server system 14. Preferably, said request takes the form of an SMS message, but a WAP message or an Internet message are also possible.

In another step 108, the server system 14 receives said request and verifies that the user is entitled to use the service by transmitting the total amount for the requested franking services and the telephone number of the handheld communications device (conventionally obtained on the basis of the International Mobile Subscriber Identity (IMSI) number or International Mobile Equipment Identity (IMEI) number of the communications device, which number is transmitted during the call) to the second server system 16 in charge of verifying, by accessing its customer database, whether the user's account has sufficient telephone credit for paying for the amount of the requested franking service. The customer database can, for example, contain the surname, forename, and address of each customer, the telephone number and customer account number of each customer, and any other information (in particular the balance of the customer's account) making it possible for the customer to be identified properly.

If the telephone operator considers that the credit of the user is insufficient (test of step 110), the second server system so informs the first server system which then asks the user to purchase more credit and the call is then interrupted (step 112). Otherwise, if the user's use entitlements are valid (credit sufficient), in response to the franking service payment request, the first server system generates, in step 114, a second item of encoded information (which can, in addition, be encrypted or signed using a private key of the first server system) and sends it to the handheld communications device. Depending on the implementation in question, this encoded information can advantageously be in the form of a preferably two-dimensional bar code, displayed on the handheld communications device, and can, as above, be sent by means of an SMS-type short message.

The user then, in a next step 116, merely has to transmit said second item of encoded information to the mail-handling machine. Depending on the implementation in question, that transmission can be performed via the data transmit/receive modules 10A, 12A, or by means of the bar code reader 10B to which the screen of the handheld communications device is presented. Finally, in a next step 118, the mail-handling machine verifies the received information, and, if it is valid, activates the print module of the mail-handling machine so as to enable the user to proceed with the franking operations up to the total authorized amount of franking. At the end of the operation, the total amount of the franking transaction, the date of the transaction, and the itemized statement of the various options of the requested franking service are stored in the secure portion of the mail-handling machine whose contents are transferred at least once per day to the first server system for verification purposes, and the print module is deactivated.

It can be noted that, when the second item of encoded information is encrypted by the private key of the server system 14, the verification operation is conventionally performed by decryption by means of an associated public key.

What is claimed is:

1. A method of automatically paying for a franking service in a self-service mail-handling machine, said method comprising the following steps:
a user inputting the parameters of the requested franking service into the mail-handling machine;
the mail-handling machine generating a first item of encoded information relating to the requested franking service;
a handheld communications device of the user obtaining the first item of encoded information;
the handheld communications device automatically sending a payment request for paying for the requested franking service to a first server system;
the first server system receiving said request and verifying the use entitlements of the user;
if the use entitlements are valid, the first server system generating a second item of encoded information in response to the payment request for paying for the franking service;
the handheld communications device of the user obtaining said second item of encoded information;
transmitting the second item of encoded information obtained in this way by the handheld communications device to the mail-handling machine;
the mail-handling machine verifying the second item of encoded information transmitted in this way; and
if the received second item of encoded information is valid, activating the mail-handling machine so as to implement the requested franking service.

2. A method according to claim 1, wherein the step of verifying the use entitlements comprises verifying the telephone number of the user and verifying the corresponding telephone credit with a second server system.

3. A method according to claim 1, wherein each of said first and second items of encoded information is in the form of an advantageously two-dimensional bar code.

4. A method according to claim 3, wherein the step of obtaining said first item of encoded information comprises digitally capturing said first item of encoded information by photographing a screen of the mail-handling machine by means of a digital camera incorporated in the handheld communications device of the user.

5. A method according to claim 1, wherein the step of obtaining said first item of encoded information comprises the handheld communications device receiving a radio frequency or infrared signal transmitted by the mail-handling machine and including said second item of encoded information.

6. A method according to claim 1, wherein the step of automatically sending the payment request for paying for the franking service comprises sending an SMS message to a phone number extracted automatically from said first item of encoded information.

7. A method according to claim 1, wherein said first item of encoded information further includes at least the amount of the requested franking service and the identity number of the mail-handling machine.

8. A method according to claim 1, wherein the step of sending the second item of encoded information comprises sending an SMS message including the second item of encoded information to the handheld communications device of the user.

9. A method according to claim 1, wherein the step of transmitting the second item of encoded information to the mail-handling machine comprises the handheld communications device transmitting a radio frequency or infrared signal including said second item of encoded information.

10. A method according to claim 11 wherein the step of transmitting the second item of encoded information to the mail-handling machine comprises presenting a screen of the handheld communications device to a bar code reader of the mail-handling machine.
